(19) United States
(12) Patent Application Publication
(10) Pub. No.: US 2002/0142263 A1
(43) Pub. Date: Oct. 3, 2002

(54) Single dose dental applicator

(76) Inventor: Cary B. Robinson, Radnor, PA (US)

Correspondence Address: NORMAN E. LEHRER, 1205 North Kings Highway, Cherry Hill, NJ, 08034, US

(21) Appl. No.: 09/819,742

(22) Filed: Mar. 29, 2001

(51) Int. Cl. A61C 5/04; A61C 17/02

(52) U.S. Cl. 433/89; 433/80

(57) ABSTRACT

A single dose dental applicator which includes a capsule with a first end and a second is disclosed. Extending outwardly from the first end of the capsule is an elongated nozzle. The end of the nozzle has a tip which is frangible. The second end of the capsule has a flat portion which acts as a handle. A quantity of dental varnish is housed within the capsule. In order to use the applicator, the dentist breaks the tip of the nozzle and inserts the nozzle into the cavity. The dentist then holds the handle and squeezes the capsule, thereby releasing the varnish housed therein. The quantity of varnish housed within the capsule is sufficient to line one tooth. The capsule is then discarded.

### BACKGROUND OF THE INVENTION

The present invention is directed toward a system for coating a cavity within a tooth and more particularly, toward a disposable applicator which also prevents cross contamination among patients.

When a dentist prepares a tooth for restoration, he or she coats the portion of the tooth being treated with a material in order to protect it. For example, if the dentist is filling a cavity, he or she removes the decayed portion of the tooth by drilling. A cavity is formed in the tooth. Before the cavity is filled, it is lined with a protective material, such as a varnish. The protective material provides a protective seal against penetration of material which may injure the tooth or cause further decay and acts as a barrier between the filling and the body of the tooth.

The most common way to line the cavity is by brushing the varnish onto the cavity. The varnish is usually available in a bottle. A small brush is dipped into the bottle and is then used to brush the cavity. The material dries, leaving a lining or coating within the cavity. The problem with this method is that cross-contamination occurs. That is, the bottle of material and/or the brush is reused. Thus, if the dentist does not clean the brush properly before reinserting it into the bottle, bacteria from one patient may be transferred to another patient.

An improvement to the aforementioned method is described in U.S. Pat. No. 2,654,948 to Rubin which discloses the use of a small tube which houses the lining material and a metal nozzle which screws onto the tube. To line or coat a cavity, the nozzle is applied to the tube. The end of the nozzle is then inserted down into the cavity and the tube is squeezed so that a sufficient amount of the material is injected into the cavity. The problem with this method, however, is that cross-contamination is still not prevented in that the nozzles are designed to be sterilized and reused with different patients. Furthermore, any material remaining in the tube may either be used on another patient or thrown away, thereby further causing possible cross-contamination or a waste of material.

### SUMMARY OF THE INVENTION

The present invention is designed to overcome the deficiencies of the prior art discussed above. It is an object of the present invention to provide a disposable dental applicator which houses a dental varnish.

It is another object of the present invention to provide an applicator which contains a single dose of the varnish.

It is a further object of the present invention to provide a dental applicator which prevents cross-contamination among patients.

In accordance with the illustrative embodiments demonstrating features and advantages of the present invention, there is provided a dental applicator which includes a capsule with a first end and a second end. Extending outwardly from the first end of the capsule is an elongated nozzle. The end of the nozzle has a tip which is frangible. The second end of the capsule has a flat portion which acts as a handle. A quantity of dental varnish is housed within the capsule. In order to use the applicator, the dentist breaks the tip of the nozzle and inserts the nozzle into the cavity. The dentist then holds the handle and squeezes the capsule, thereby releasing the varnish housed therein. The quantity of varnish housed within the capsule is sufficient to line one tooth. The capsule is then discarded.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 illustrates the applicator of the present invention being used on a patient;

FIG. 2 is a rear perspective view of the applicator;

FIG. 3 illustrates the frangible tip of the applicator being broken prior to the applicator being used; and

FIG. 4 is a cross-sectional view of the applicator of the present invention taken through line 4-4 of FIG. 3.

### DETAILED DESCRIPTION OF THE PREFERRED EMBODIMENT

Referring now to the drawings in detail wherein like reference numerals have been used throughout the various figures to designate like elements, there is shown in FIG. 2 a disposable dental applicator constructed in accordance with the principles of the present invention and designated generally as 10.

The present invention essentially includes a dental applicator 10 which includes a capsule 12 with a first end 14 and a second end 16. Extending outwardly and at an angle from the first end 14 of the capsule 12 is an elongated nozzle 18. The end of the nozzle 18 has a tip 20 which is frangible. (See FIG. 2.) The second end 16 of the capsule 12 has a flat portion 22 which acts as a handle. A quantity of protective material 24, such as dental varnish, is housed within the capsule 12. (See FIG. 4.)

The entire applicator 10 is preferably molded as a single unit. It may be made from any suitable plastic material such as polypropylene or the like. Preferably the applicator is transparent or at leas translucent so that the contents can be observed from the outside. This allows the dentist to know the amount of varnish that remains in the capsule as the applicator is being used.

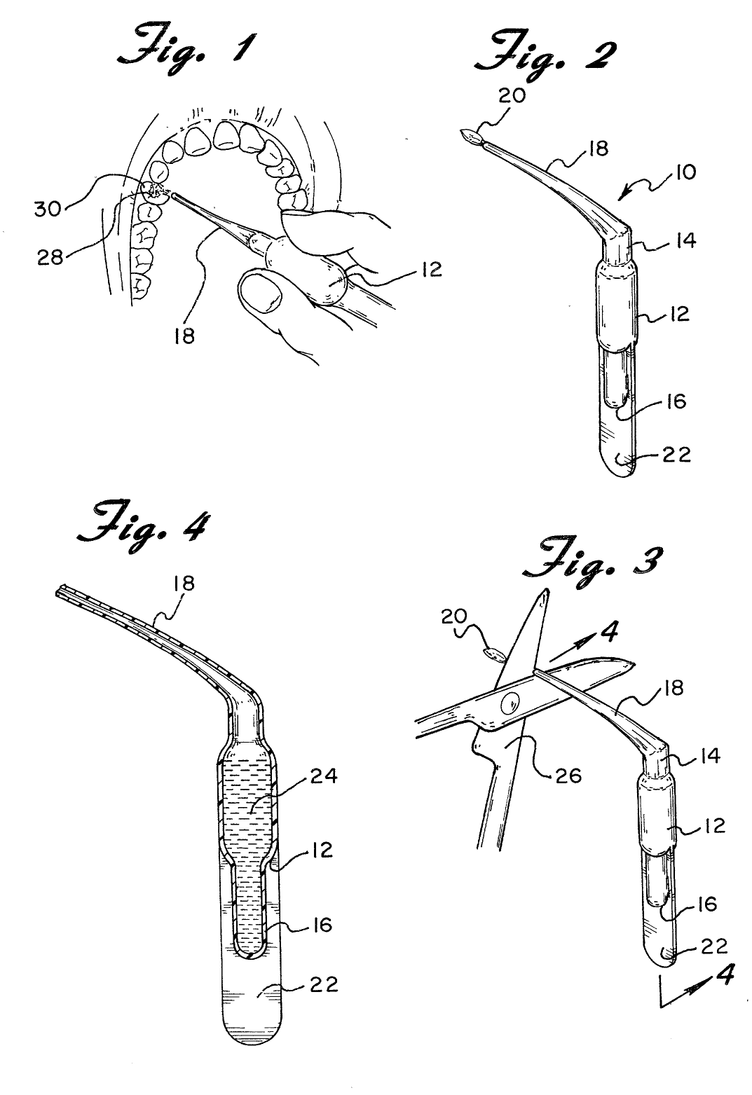

In order to use the applicator, the dentist snips with scissors 26 or otherwise breaks the tip 20 of the nozzle 18. (See FIG. 3.) The dentist then inserts the nozzle 18 into a cavity 28 formed within a patient's tooth 30. (See FIG. 1.) The dentist then holds the handle 22 and squeezes the capsule 12, thereby dispensing the varnish 24 housed therein through the nozzle 18. The quantity of varnish 24 housed within the capsule 12 is sufficient to line one tooth. For example, it may hold approximately 0.2 ml of varnish. The capsule 12 is then discarded, thereby decreasing or preventing any chance of causing cross-contamination among patients.

The present invention may be embodied in other specific forms without departing from the spirit or essential attributes thereof and accordingly, reference should be made to the appended claims rather than to the foregoing specification as indicating the scope of the invention.

I claim:

1. A combination of a single dose dental applicator and a dental varnish comprising:
a capsule having a first end and a second end;
a handle portion attached to said second end;
a quantity of dental varnish housed within said capsule; and
means for dispensing said varnish secured to said first end of said capsule.

2. The combination of a single dose dental applicator and a dental varnish of claim 1 wherein said dispensing means includes an elongated nozzle.

3. The combination of a single dose dental applicator and a dental varnish of claim 2 wherein said nozzle has a frangible tip.

4. The combination of a single dose dental applicator and a dental varnish of claim 1 wherein said quantity of dental varnish is approximately 0.2 ml.
